(19) United States
(12) Patent Application Publication
(10) Pub. No.: US 2012/0052315 A1
(43) Pub. Date: Mar. 1, 2012

(54) MECHANICAL PARTS HAVING INCREASED WEAR-RESISTANCE

(75) Inventor: Habib Skaff, Tampa, FL (US)

(73) Assignee: SKAFF CORPORATION OF AMERICA, INC., Tampa, FL (US)

(21) Appl. No.: 13/224,106

(22) Filed: Sep. 1, 2011

Related U.S. Application Data
(63) Continuation of application No. 12/052,990, filed on Mar. 21, 2008, now Pat. No. 8,012,274.
(60) Provisional application No. 60/896,468, filed on Mar. 22, 2007.

(51) Int. Cl. B32B 15/04

(52) U.S. Cl. 428/469

(57) ABSTRACT

The present invention relates to wear-resistant mechanical parts.

### CROSS-REFERENCE TO RELATED APPLICATIONS

The present application claims priority to U.S. provisional patent application Ser. No. 60/896,468, filed Mar. 22, 2007, the entirety of which is hereby incorporated herein by reference.

### BACKGROUND OF THE INVENTION

The production of very hard surfaces of borides on metal articles by diffusion of boron into the surfaces thereof, has long been known. For this purpose it is possible, for example, to use gaseous boriding agents, such as diborane, boron halides, and organic boron compounds, as well as liquid substances, such as borax melts, with viscosity-reducing additives, with or without the use of electric current. The use of such boriding agents, however, has never gained commercial importance due to the fact that they are not very economical, they are toxic, and because of the non-uniformity of the boride layers obtained therewith. As a result, it remains desirable to provide a metallic object, having at least a portion of a surface of the object that is borided and therefore wear-resistant.

### BRIEF DESCRIPTION OF THE DRAWINGS

FIG. 1 depicts the SEM spectrum and quantitative results of a sample

FIG. 2 depicts the SEM spectrum and quantitative results of a sample.

FIG. 3 depicts the SEM spectrum and quantitative results of a sample.

FIG. 4 depicts a starting sample.

### DETAILED DESCRIPTION OF CERTAIN EMBODIMENTS

### Substrates

In certain embodiments, the present invention provides an object wherein at least a portion of a surface of the object comprises a material that is borided. In some embodiments, the present invention provides an object wherein at least a portion of a surface of the object comprises a metallic material that is borided. Such objects include any metallic object, or portion thereof, that is suitable for boriding and would benefit from the effects of boriding. One of ordinary skill in the art will recognize that numerous objects, or a portion thereof, would benefit from the wear-resistance imparted upon metallic surfaces by the process of boriding. Objects having at least a portion subject to wear by corrosion, abrasion, or erosion would particularly benefit from the wear-resistant effects of boriding. Such objects include those used in the automotive, aerospace, farming, ocean vessel, medical, dental, construction, sports equipment, ballistics, and household industries. One of ordinary skill in the art will recognize that many other wear-resistant objects are contemplated.

The object, or a portion thereof, may be fabricated from a ferrous or non-ferrous metal or metal alloy. In some embodiments, the metal or metal alloy may be steel, titanium, or a titanium or chromium alloy. In certain embodiments, the object, or a portion thereof, is substantially metallic, or may be at least 5% metallic, at least 10% metallic, at least 15% metallic, at least 20% metallic, at least 25% metallic, at least 30% metallic, at least 35% metallic, at least 40% metallic, at least 45% metallic, at least 50% metallic, at least 55% metallic, at least 60% metallic, at least 65% metallic, at least 70% metallic, at least 75% metallic, at least 80% metallic, at least 85% metallic, at least 90% metallic, or at least 95% metallic.

Typical substrate materials include steel alloys, such as stainless steels, titanium alloys, nickel base and cobalt base super-alloys, dispersion-strengthened alloys, composites, single crystal and directional eutectics. In certain embodiment, the substrate material is a stainless steel or a titanium alloy. In some embodiments, the substrate material is a cobalt-containing or silicon-containing material. In other embodiments, the substrate material is silicon.

Examples of some of the nominal compositions of typical substrate materials that are in accordance with the features of the present invention include AM350 (Fe, 16.5Cr, 4.5Ni, 2.87Mo, 0.10C); AM355 (Fe, 15.5CR, 4.5Ni, 2.87Mo, 0.12C); Custom 450 (Fe, 15Cr, 6Ni, 1 Mo, 1.5Cu, 0.5Cb, 0.05C); Ti-6Al-4V; Ti-6Al-25n-4zr-2Mo; Ti-6Al-25n-4Zr-6Mo; and Ti-10V-2Fe-3Al.

In certain embodiments, the wear-resistant object comprises an iron-containing metal. Iron-containing metals are well known to one of ordinary skill in the art and include steels, high iron chromes, and titanium alloys. In certain embodiments, the iron-containing metal is a stainless steal or 4140 steal. In other embodiments, the stainless steal is selected from 304, 316, 316L steal. According to one embodiment, the iron-containing metal is a steal selected from 301, 301L, A710, 1080, or 8620. In other embodiments, the metal surface to be boronized is titanium or a titanium-containing metal. Such titanium-containing metals include titanium alloys.

As described generally above, wear-resistant objects of the present invention include those used in the medical industry. Such objects are well known in the art and include surgical instruments, such as instruments having teeth, serrations, a cutting edge, or being otherwise susceptible to wear a surgical instrument having a cutting edge which does not need frequent sharpening. “Surgical scissors,” as used herein, means straight, curved, acutely curved and very acutely curved scissors for surgical use. The present invention also contemplates other stainless steel or titanium surgical instruments, including, without limitation, cutting instruments (e.g. scalpels), grasping and holding instruments, electrosurgical instruments, cautery instruments, needle holders, osteotomes and periosteotomes, chisels, gouges, rasps, files, saws, reamers, wire twisting forceps, wire cutting forceps, ring handled forceps, tissue forceps, cardiovascular clamps, and rongeurs. Also contemplated are objects for use in orthopedics including screws, pins, wires, and the like.

In other embodiments, the present invention provides an implantable device having at least a portion that is wear-resistant in accordance with the present invention. Such implantable medical devices are well known in the art. Representative examples of implants and surgical or medical devices contemplated by the present invention include cardiovascular devices (e.g., chronic infusion lines or ports, pacemaker wires, implantable defibrillators); neurologic/neurosurgical devices (e.g., ventricular peritoneal shunts, ventricular atrial shunts, nerve stimulator devices; Additional implantable medical devices include esophageal stents, gastrointestinal stents, vascular stents, biliary stents, colonic stents, pancreatic stents, ureteric and urethral stents, lacrimal stents, Eustachian tube stents, fallopian tube stents and tracheal/bronchial stents.

In other embodiments, wear-resistant objects of the present invention are those used in the dental or orthodontic industries. Such objects are well known in the art and include cleaning tools, braces, Mara apparatus, orthodontic wire, brackets, molar bands, ligatures, and the like.

In certain embodiments, wear-resistant objects of the present invention are those used in the automotive industry. Such objects are well known in the art and include shock absorbers, springs, gears, rotors, calipers, bearings, brake rotors, calipers, car frames, and internal combustion engine parts including valves, pistons, cylinder, spark plugs, drive shaft, crank shaft, cam shaft, rocker arms, timing gears, timing chain, heads, block, fan blades, manifold, universal joints, transmission parts, cylinder lining, and gas lines, to name a few.

In certain embodiments, wear-resistant objects of the present invention multiple edge or single edge cutting tools. Such objects are well known in the art and include knives, razors, scissors, sickles, utility knife blades, stone-cutting blades, mower blades, axes, hatchets, saw blades (e.g. circular saw blades, chain-saw blades, hack saw blades, jigsaw blades, reciprocating saw blades, band saw blades, and concrete saw blades), lathes, planer blades (eg block plane, jack plane), shaper blades, and the like.

In certain embodiments, the present invention provides a wear-resistant tool. Tools are well known in the art and included hand tools and machine tools. Exemplary tools include chasers, wrenches, hammers, screwdrivers, pliers, lock mechanisms, knurling tools, ratchet sockets, chisels, router bits, drill bits, broaches, drills, gears shapers, hones, lathes, shapers, grinders, and files.

In certain embodiments, the present invention provides a wear-resistant fastener. Fasteners are well known in the art and include nails, screws, staples, bolts, nuts, washers, hinges, clips, chain links, locks, clamps, pins (e.g. cotter pin), hooks, pulleys, and rivets.

In other embodiments, the present invention provides a wear-resistant wire. Wires are well known in the art and include wire for medical use, cable (i.e. wire rope), and wire for use in musical instruments (e.g. piano wire or guitar string).

In certain embodiments, the present invention provides a wear-resistant mechanical part, or portion thereof, for use in heavy equipment, including farming equipment. One of ordinary skill in the art will recognize that many components of heavy equipment would benefit from wear-resistance in accordance with the present invention. Such mechanical parts and equipment include plows, hoes, combine parts, wheel barrows, pitchforks, roll cages, shovels, trailer hitches, bulldozer blades, excavator buckets, grader blades, draggers, snow plows, wheels, tracks (eg bulldozer), drilling machines, pile drivers, pavers, harvesters, roller-compacters, skid loaders, trenchers, and cranes.

In certain embodiments, the present invention provides a wear-resistant mechanical part, or portion thereof, for use in sporting equipment. One of ordinary skill in the art will recognize that many components of sporting equipment would benefit from wear-resistance in accordance with the present invention. Such components and sporting goods include golf clubs (e.g. shaft and head), ice skate blades, ski edges, snow board edges, horse shoes, dart tips, and the like.

In other embodiments, the present invention provides a wear-resistant mechanical part, or portion thereof, for use in aircraft, including jet engines. One of ordinary skill in the art will recognize that many components of aircraft would benefit from wear-resistance in accordance with the present invention. Such components include turbines, fan blades, nozzles, rotors, propellers, and the like.

In other embodiments, the present invention provides a wear-resistant mechanical part, or portion thereof, such as bullets, shell casings, gun/rifle barrels, gun/rifle hammers, arrow heads and shafts, sword blades, armor, and the like.

In still other embodiments, the present invention provides a wear-resistant mechanical part, or portion thereof, for use in nautical equipment, including boats and docks. One of ordinary skill in the art will recognize that many components of nautical equipment would benefit from wear-resistance in accordance with the present invention. Such components include sail boat masts, anchors, propellers, ship hulls, hooks, and cleats, among others.

### Boriding

The use of diffusion-based treatments such as nitriding, carburization, and boriding to increase surface hardness and resistance to wear is well known. Boriding can produce a harder surface than nitriding or carburization and is suitable for some steel alloys for which nitriding or carburization are less optimal. Boriding also improves the corrosion resistance and reduces the coefficient of friction more than carburization, increasing the lifetime of parts. Even a 10% improvement in part life can create immense savings over the course of utilizing an object in accordance with the present invention.

Various methods of boronizing metallic surfaces are known. Such methods produce a boron layer on a metal surface. Typically, these methods utilize reactive boron species which diffuse into the metal surface. Such reactive boron species include gaseous diborane and boron trihalides, including BCl₃ and BF₃. Other techniques for increasing surface hardness include the simple deposition of a boron-containing layer at the surface of a material. For example, electrochemistry may be employed to form a layer of iron boride at the surface of a component.

Alternatively, superabrasive composites including materials such as diamond or cubic boron nitride may be electroplated onto metallic components, or metal/metal boride mixtures may be thermally sprayed onto components. However, layers formed by these methods may not be chemically or mechanically integrated with the bulk material. Boriding provides greater integration of the boron-containing layer with the substrate. This integration increases the strength of the interface between the boride-containing layer and the substrate, further reducing galling, tearing, seizing, and other forms of wear in which a material flakes from the surface.

One method for boriding metallic surfaces is the “pack” method. In this method, the boron source is in the form of a solid powder, paste, or in granules. The metal surface is packed with the solid boron source and then heated to release and transfer the boron species into the metal surface. This method has many disadvantages including the need for using a large excess of the boron source resulting in the disposal of excessive toxic waste.

Another method for boriding metallic surfaces is the “paste” method. Such pastes are applied by dipping, brushing, or spraying. Paste consistency is variable within wide limits.

Another method for boriding metallic surfaces utilizes a plasma charge to assist in the transfer of boron to the metal surface. Typically, plasma boronization methods utilize diborane, BCl₃, or BF₃ where the plasma charge is applied to the gaseous boron-containing reagent to release reactive boron species. See U.S. Pat. No. 6,306,225 and U.S. Pat. No. 6,783,794, for example. However, these methods utilize corrosive and highly toxic gases and are thus difficult to utilize on an industrial scale.

Plasma boriding processes have several advantages, including speed and localized heating of the substrate. This prevents the bulk metal in the borided piece from annealing, obviating additional heat treatments to restore the original microstructure and crystal structure.

In another embodiment, a potassium haloborate may be decomposed to the potassium halide salt and the boron trihalide, which is then fed into an inert gas stream for plasma boriding. In one embodiment, the potassium haloborate is potassium fluoroborate. It is contemplated that this technique facilitates boriding of larger parts more economically and safely than plasma boriding techniques employing organoborates or boron halides.

Use of KBX₄ is advantageous in that it is a solid substance which is readily available and easily handled. In certain embodiments, KBX₄ is provided in solid form in the presence of a metal surface to be borided. Heat is applied such that the KBX₄ releases BX₃ gas to which a plasma charge is applied. Without wishing to be bound by any particular theory, it is believed that the plasma charge results in the formation of one or more active boron species which diffuse into the metal surface. As used herein, the term “activated boron species” refers to any one or more of the boron species created from applying the plasma charge to the gas resulting from heating KBX₄. In certain embodiments, the one or more activated boron species include, but are not limited to, B⁺, BX⁺, BX₂⁺, and BX₃⁺.

As used herein, the terms “boriding” and “boronizing” are used interchangeably and refer to the process of incorporating a boron layer on a metal surface.

As used herein, the term “plasma” refer to an ionized gas and the term “plasma charge” refers to an electric current applied to a gas to form a plasma. In certain embodiments, a plasma for use in the present invention comprises one or more activated boron species including, but not limited to, B⁺, BX⁺, BX₂⁺, and BX₃⁺, wherein each X is a halogen.

As used herein, the term “glow discharge” refers to a type of plasma formed by passing a current at 100 V to several kV through a gas. In some embodiments, the gas is argon or another noble gas.

In certain embodiments, each X is chlorine and the KBX₄ is KBCl₄.

In other embodiments, each X is fluorine and the KBX₄ is KBF₄.

In certain embodiments, the present invention provides any of the objects described above and herein, wherein at least a portion of a surface of the object comprises a metallic material that is borided by a method comprising the steps of:
(a) providing KBX₄, wherein each X is halogen;
(b) heating the KBX₄ at a temperature sufficient to release BX₃; and
(c) applying a plasma charge to the BX₃ to create one or more activated boron species for diffusing into the metal surface.

In other embodiments, the boriding method comprises the steps of:
(a) providing KBX₄, wherein each X is halogen, in the presence of the metal surface;
(b) heating the KBX₄ at a temperature sufficient to release BX₃; and
(c) applying a plasma charge to the BX₃ to create one or more activated boron species for diffusing into the metal surface.

In certain embodiments, the metal surface to be boronized is an iron-containing metal. Iron-containing metals are well known to one of ordinary skill in the art and include steels, high iron chromes, and titanium alloys. In certain embodiments, the iron-containing metal is a stainless steal or 4140 steal. In other embodiments, the stainless steal is selected from 304, 316, 316L steal. According to one embodiment, the iron-containing metal is a steal selected from 301, 301L, A710, 1080, or 8620. In other embodiments, the metal surface to be boronized is titanium or a titanium-containing metal. Such titanium-containing metals include titanium alloys.

In other embodiments, the KBX₄ is provided in solid form in a chamber containing the metal surface to be borided. The KBX₄ is heated to release BX₃. A plasma charge is applied at the opposite side of the chamber to create a plasma comprising one or more activated boron species. The temperature at which the KBX₄ is heated is sufficient to release BX₃ therefrom. In certain embodiments, the KBX₄ is heated at a temperature of 700 to 900° C.

The amount of KBX₄ utilized in methods of the present invention is provided in an amount sufficient to maintain a pressure of about 10 to about 1500 Pascals within the reaction chamber. In certain embodiments, the pressure is from about 50 to about 1000 Pascals. In other embodiments, the pressure is from about 100 to about 750 Pascals. One of ordinary skill in the art will appreciate that the thermodecomposition of KBX₄ to BX₃ results in an increase of pressure within the reaction chamber. Without wishing to be bound by any particular theory, it is believed that the number of moles of BX₃ gas created may be calculated by measuring the increase of pressure.

In certain embodiments, hydrogen gas is introduced into the chamber with the KBX₄ and BX₃ resulting from the thermodecomposition thereof. Without wishing to be bound by any particular theory, it is believed that elemental hydrogen facilitates the decomposition of BX₃ into the one or more activated boron species upon treatment with the plasma charge. In certain embodiments, hydrogen gas is introduced in an amount that is equal to or in molar excess as compared to the amount of BX₃ liberated.

In some embodiments, the BX₃ and optional hydrogen gases are carried into a plasma by a stream of an inert gas, for example, argon. The plasma allows quicker diffusion of reactive elements and higher velocity impact of reactive boron species against the metal surface being treated. In certain embodiments, the plasma is a glow plasma. The substrate may be any material that is suitable for use with plasma treatment methods, for example, steels or titanium alloys. The KBX₄ may be decomposed in a separate decomposition chamber connected to the plasma chamber, or both the decomposition and the plasma treatment may occur in separate areas of a single reaction vessel.

As described herein, methods of the present invention include the step of applying a plasma charge to create one or more activated boron species. In certain embodiments, the plasma charge is a pulsed plasma charge. In other embodiments, the plasma charge is applied wherein the voltage is regulated from between about 0 to about 800 V. In still other embodiments, the amperage is about 200 A max.

### EXAMPLES

### Example 1

A steel part is placed into a reaction chamber along with 50 g KBF₄ in a boron nitride crucible. The reaction chamber is evacuated to 0.01 Pa. The crucible is heated to 900° C. resulting in decomposition of KBF₄ to BF³. A 10% H₂/Ar₂ gas mixture is added to the reaction chamber to a pressure of 500 Pa. An electrical discharge is applied at 600 V and 150 Amps. The reaction is continued for about 3 hours or until desired boron penetration is accomplished.

### Example 2

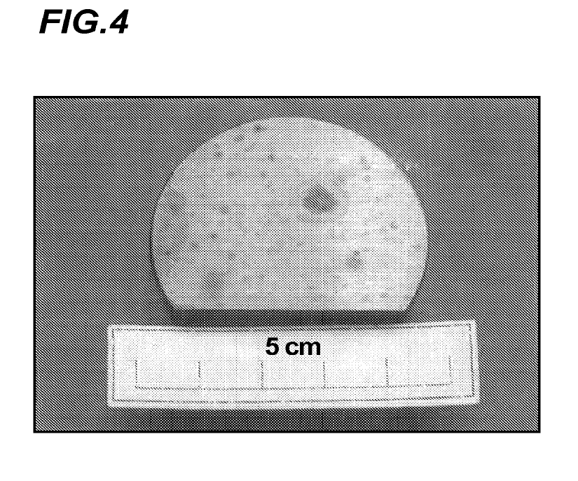

A “disk prototype”, (FIG. 4), with a diameter of 45 mm and a thickness (or gauge) of 15 mm., which had been manufactured out of ARMCO iron. It was known that this prototype had been subjected to a heat treatment of approximately 450-500 centigrade. The assembly was further identified by the letter A on its surface. This prototype exhibited, on both the front and lateral surfaces, marks of “surface adhesion”, which were to be analyzed by means of scanning electron microscope medium-energy-dispersing x-ray analysis.

The surface analysis was conducted by means of the scanning electron microscope middle-energy-dispersing x-ray analysis (EDX). All measurements/readings were conducted with an acceleration voltage of 20 kV. In principle, through the EDX measurements. a qualitative estimation of the carbon content can be observed with this analytical method.

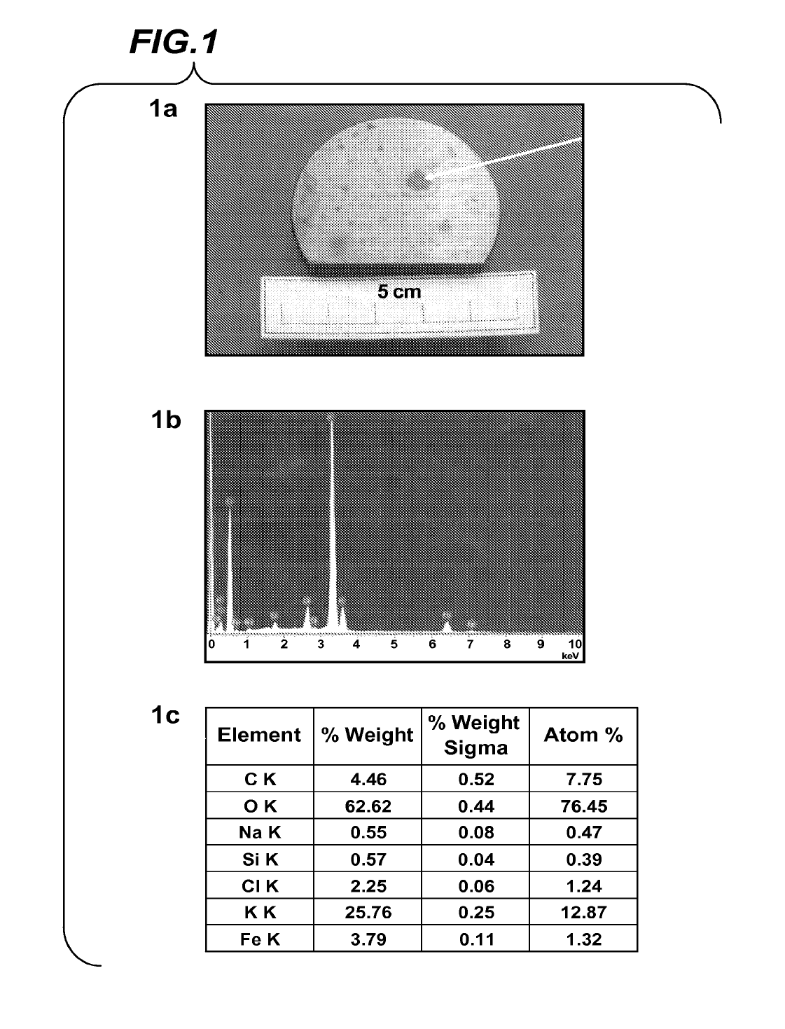

Initially, the EDX Spectra had been recorded in two positions of the flecked surface adhesion. The first spectrum from one of the larger marks showed high quantities of oxygen (62.62%) and Potassium (25.76%) (FIG. 1). Additionally, the elements Sodium (0.55%), Chlorine (2.25%) and Silicon (0.57%) were detected. The remaining portion of the iron (3.79%) had to be assigned to the basic material. In FIG. 1, picture 2a depicts the marking of the measurement position; picture 2b depicts the SEM spectrum of the area in picture 2a; and picture 2c depicts the quantitative results of the SEM spectrum from picture 2b.

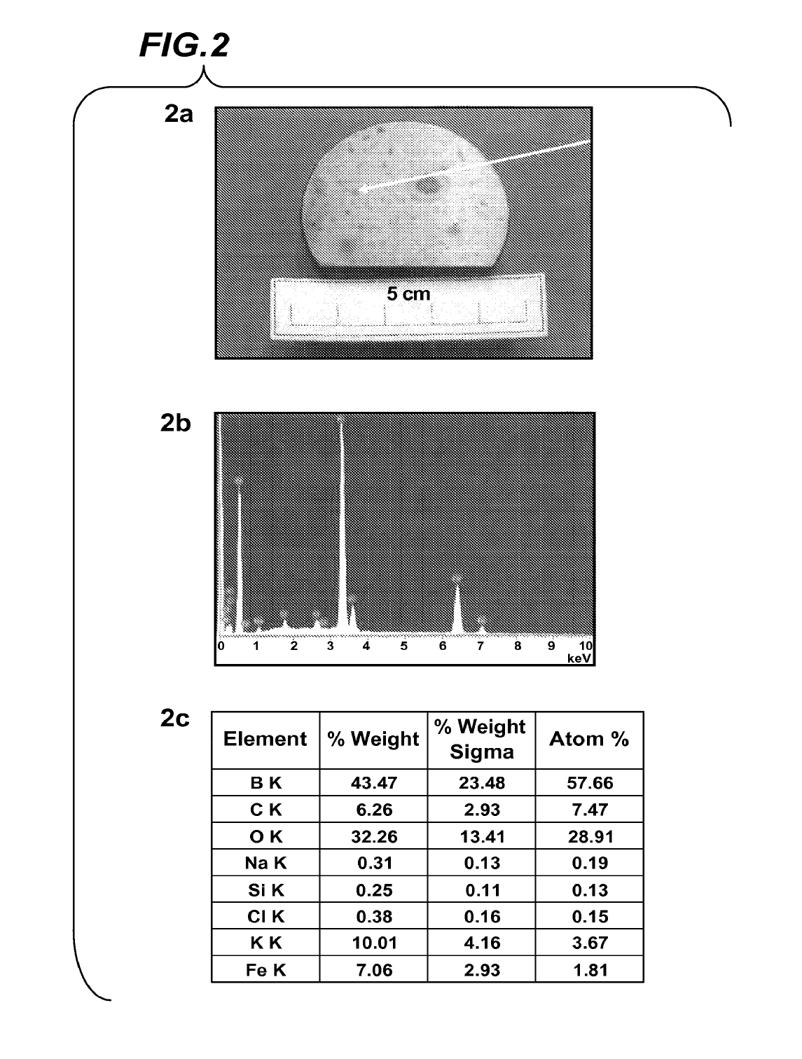

The second surface analysis on one of the smaller flecks (FIG. 2) showed additionally, in comparison to the elements found in the first measurement, significantly high boron content (43.47%). The alkali-metals sodium (0.31%) and Potassium (10.01%), as well as the elements Silicon (0.25%) and Chlorine (0.38%) lay clearly under the values of the measurement of the larger spot. The oxygen content had halved itself by nearly 32%. In FIG. 2, picture 3a depicts the measurement position for the SEM measurement; picture 3b depicts the SEM spectrum of the area in picture 3a; and picture 3c depicts the quantitative results of the SEM measurement.

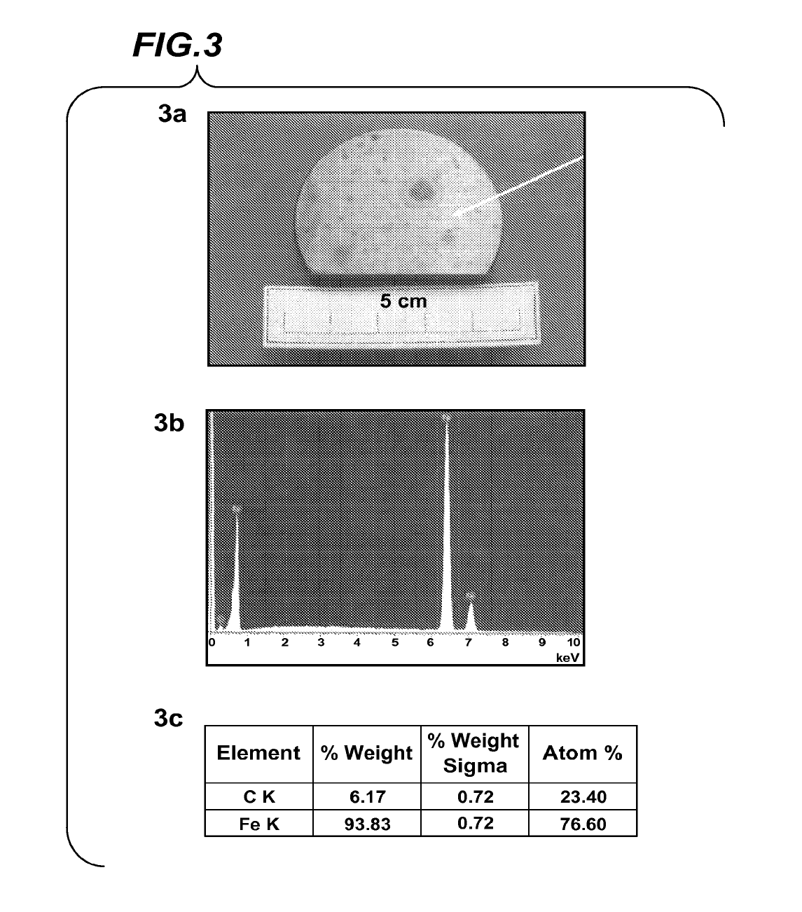

In the last measurement. the surface area had been measured in an unaffected (FIG. 3). In this position, it shows a typical composition of ARMCO-iron. In FIG. 3, picture 4a depicts the measurement position for the SEM measurement; picture 4b depicts the SEM spectrum of the area in picture 4a; and picture 4c depicts the quantitative results of the SEM measurement.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1-15. (canceled)

16. A wear-resistant mechanical part, or portion thereof, of heavy equipment, wherein said part, or portion thereof, comprises a metallic surface that is borided.

17. The wear-resistant mechanical part, or portion thereof, according to claim 16, wherein said part, or portion thereof, is of farming equipment.

18. The wear-resistant mechanical part, or portion thereof, according to claim 16, wherein said part, or portion thereof, is selected from plows, hoes, combine parts, wheel barrows, pitchforks, roll cages, shovels, trailer hitches, bulldozer blades, excavator buckets, grader blades, draggers, snow plows, wheels, tracks, drilling machines, pile drivers, pavers, harvesters, roller-compacters, skid loaders, trenchers, and cranes.

19. The wear-resistant mechanical part, or portion thereof, according to claim 18, wherein said metallic surface, or portion thereof, is borided by deposition or diffusion.

20. The wear-resistant mechanical part, or portion thereof, according to claim 18, wherein said metallic surface, or portion thereof, is borided by pack boriding.

21. The wear-resistant mechanical part, or portion thereof, according to claim 18, wherein said metallic surface, or portion thereof, is borided by paste boriding.

22. The wear-resistant mechanical part, or portion thereof, according to claim 18, wherein said metallic surface, or portion thereof, is borided by plasma boriding.

23. A wear-resistant tool, or portion thereof, wherein said tool, or portion thereof, comprises a metallic surface that is borided.

24. The tool, or portion thereof, according to claim 23, wherein said tool is selected from chasers, wrenches, hammers, screwdrivers, pliers, lock mechanisms, knurling tools, ratchet sockets, chisels, router bits, drill bits, broaches, drills, gears shapers, hones, lathes, shapers, grinders, and files.

25. The tool, or portion thereof, according to claim 24, wherein said metallic surface, or portion thereof, is borided by deposition or diffusion.

26. The tool, or portion thereof, according to claim 24, wherein said metallic surface, or portion thereof, is borided by pack boriding.

27. The tool, or portion thereof, according to claim 24, wherein said metallic surface, or portion thereof, is borided by paste boriding.

28. The tool, or portion thereof, according to claim 24, wherein said metallic surface, or portion thereof, is borided by plasma boriding.

29. A wear-resistant cutting tool, or portion thereof, wherein said cutting tool, or portion thereof, comprises a metallic surface that is borided.

30. The wear-resistant cutting tool, or portion thereof, according to claim 29, wherein said cutting tool is multiple edged or single edged.

31. The wear-resistant cutting tool, or portion thereof, according to claim 29, wherein said cutting tool is selected from knives, razors, scissors, sickles, utility knife blades, stone-cutting blades, mower blades, axes, hatchets, saw blades, lathes, planer blades, and shaper blades.

32. The wear-resistant cutting tool, or portion thereof, according to claim 31, wherein said metallic surface, or portion thereof, is borided by deposition or diffusion.

33. The wear-resistant cutting tool, or portion thereof, according to claim 31, wherein said metallic surface, or portion thereof, is borided by pack boriding.

34. The wear-resistant cutting tool, or portion thereof, according to claim 31, wherein said metallic surface, or portion thereof, is borided by paste boriding.

35. The wear-resistant cutting tool, or portion thereof, according to claim 31, wherein said metallic surface, or portion thereof, is borided by plasma boriding.
